(19) United States
(12) Patent Application Publication
(10) Pub. No.: US 2026/0216811 A1
(43) Pub. Date: Jul. 30, 2026

(54) METHOD AND SYSTEM FOR AUTOMATICALLY GENERATING A WELD PLAN FOR A (SEMI-)UNIQUE WORK PIECE

(71) Applicant: KRANENDONK BEHEERSMAATSCHAPPIJ B.V., TIEL (NL)

(72) Inventors: Johannes Petrus Hubertus Justin GERAERDS, TIEL (NL); Bart VAN DAM, TIEL (NL)

(21) Appl. No.: 19/143,779

(22) PCT Filed: Jan. 3, 2024
(86) PCT No.: PCT/NL2024/050003

§ 371 Date: Jun. 26, 2025

(30) Foreign Application Priority Data
Jan. 3, 2023 (NL) 2033904

(51) Int. Cl. B23K 9/127; B23K 9/025; G05B 19/4097

(52) U.S. Cl. CPC B23K 9/127; B23K 9/025; G05B 19/4097; G05B 2219/45138

(57) ABSTRACT

A method for automatically generating a weld plan for a work piece, in particular a (semi-)unique work piece,
comprising the steps of:
   moving a sensor comprising a camera and a laser source across the work piece, while the laser source emits a laser beam that is projected on the work piece;
   obtaining laser line height data, representative of a local height of the laser line as projected on the work piece, using the camera;
   generating a 3D representation of the work piece, based on the local height data obtained with the sensor in step b);
   based on the 3D representation of the work piece: defining weld seams at contact lines between the profiles and the base plate; and
   generating a weld plan based on the set of weld seams.

### BACKGROUND

The present invention relates to a method and system for automatically generating a weld plan for a work piece, in particular a (semi-)unique work piece, as well as a method for automatically welding the work piece.

Automatic welding of serial products has progressed rapidly over the last decade. Fully automatic factories are presently operational, such factories welding parts together with great speed and precision, for an unlimited number of times. A requirement of such automatic processes is that the used parts are accurately positioned, have small tolerances, and that the welding actions are pre-defined and the same all the time. With such automatic welding robots, e.g. cars can be assembled step by step.

In contrast, the present invention is concerned with welding work pieces that are typically (semi-)unique, that include parts having higher tolerances, and for which a weld plan has not yet been defined. For example, the method as disclosed herein can be used to construct (parts of) large unique metal constructions, such as cruise ships, other vessels, offshore constructions, and other industrial equipment, by welding.

WO2018/215592 A1 discloses a method for automated seam welding of a work piece comprising a base plate with a pattern of upstanding profiles, said work piece being arranged on a support base, said apparatus including:
an overhead support with at least one robotic device,
at least one overhead scanner, such as a laser scanner, preferably a LIDAR scanner,
   said robotic device including an articulated arm and being configured for assuming active positions wherein a head of said articulated arm is closer to said support base,
      said head including a distance sensor,
   said robotic device carrying a welding tool with a welding gun with a welding torch,
      said sensor being positionable in different positions within local areas of said work piece in said active positions,
      said distance sensor being configured for generating local information about seam line positions within said local areas, such as information about the position of ends of profiles being within or delimiting said local areas and/or of intersections between profiles, and
a computer device for storing:
   data representing an established global 3D topographical image of said work piece,
   data representing said generated local information,
   information representing geometrical data for each of said profiles, and
   weld seam information about a weld seam to be applied for welding each profile to said base plate,
      said method comprising the steps of:
initiating a relative movement over said work piece of said at least one overhead scanner relative to said support base,
establishing said global 3D topographical image of said work piece by relative movement of said at least one overhead scanner relative to said work piece,
positioning said sensor in different positions within each of said local areas of said work piece to generate said local information about seam line positions,
storing data representing said established global 3D topographical image of said work piece,
storing data representing said generated local information,
providing information representing geometrical data for each of said profiles,
providing weld seam information about a weld seam to be applied for welding each profile to said base plate, said weld seam information comprising or consisting of information about welding leg dimension,
identifying each of said profiles by comparing said stored data representing said global 3D topographical image with said stored information representing geometrical data for each of said profiles, and
initiating welding within said locals areas and moving said welding gun along said seam lines for said seam welding using said stored weld seam information.

A LIDAR scanner as used in WO2018/215592 A1 both sends and receives a laser beam. From the time difference between sending and retrieving the beam, using the speed of light, the distance between the laser source and an object can be obtained. A disadvantage of this method is that the images obtained with the LIDAR scanner are rather course and imprecise relative to the dimensions of typical work pieces as concerned here so that only the global positioning of components and elements can be obtained with the overhead scanner. Specifically, it is unlikely to obtain a position accuracy of less than 2 mm with a LIDAR scanner. That is sufficient when determining distances between driving cars, but not when generating weld plans for work pieces. As a result, a detailed scan is required besides the overhead scan to obtain a correct “picture” of the work piece according to WO2018/215592 A1. This results in a lengthy and relatively slow method.

A further disadvantage of this method is that a database is required which stores information about the geometrical data and weld seam information for each of the used profiles. This on the one hand makes the method impossible to carry out without also purchasing a dedicated software package, and on the other hand ensures that the method cannot be completed successfully when a unique profile, not stored in the database, is used on a particular work piece.

Some of these disadvantages are partially overcome by the method proposed in WO2021/116299 A1. This latter publication discloses a method of controlling a welding operation provided by a welding machine controlled by an automatic motion generating mechanism, the method comprising the steps of:
acquiring a set of welding data during the welding operation;
computing at least a first part of the set of welding data and at least a second part of the set of welding data providing computed data, wherein the computed data indicate an abnormality;
transferring an abnormality output to a robot controller, which is controlling the welding machine and the automatic motion generating mechanism.

In particular, compared to WO2018/215592 A1 in WO 2021/116299 A1 less detailed information about the weld seam needs to be obtained before the welding process is started, as information about (abnormalities during) the welding process is generated while the welding is taking place. A database is however still needed to generate a suitable weld plan.

### SUMMARY OF THE INVENTION

The present invention aims to overcome the disadvantages associated with the method presented in WO2018/215592 A1, while taking a radically different approach than the method disclosed in WO2021/116299 A1.

In particular, it is an object of the present invention to allow a weld plan to be generated automatically, without any substantial prior knowledge about the work piece/the profiles used thereon being required.

Accordingly, a first aspect of the present invention relates to a method for automatically generating a weld plan for a work piece, in particular a (semi-)unique work piece,
the work piece comprising a base plate and one or more profiles that protrude upwardly from the base plate, the profiles including at least a T-shaped profile, an angled profile and/or a bulb profile
wherein use is made of a sensor comprising a laser source and a camera that are arranged at a fixed position at an angle of in between 10° and 60° from each other, wherein the laser source is configured for generating a laser beam and the camera is configured for recording said laser beam, the sensor being movable with respect to the work piece, wherein the method comprises the steps of:
   a) moving the sensor across the work piece, while the laser source emits a laser beam that is projected on the work piece;
   b) obtaining laser line height data, representative of a local height of the laser line as projected on the work piece, using the camera;
   c) generating a 3D representation of the work piece, based on the local height data obtained with the sensor in step b);
   d) based on the 3D representation of the work piece: defining weld seams at contact lines between the profiles and the base plate; and
   e) generating a weld plan based on the set of weld seams.

To obtain the laser line height data the sensor measures, e.g. with a distance camera, the distance to said laser line projected by the laser source. It is by using a laser source and a camera, arranged in a fixed position at an angle, that an accurate view of the work piece can be obtained, much more accurate than when a LIDAR sensor is used. An accuracy in the sub-mm range can be obtained in certain embodiments, such an accuracy being high enough to omit a time-consuming detailed measurement step along the entire profile length. As a result of the specific arrangement of the sensor, the sensor uses a triangulation principle wherein the return angle of the reflected laser light is measured by the sensor. Comparing the difference in direction between the laser beam as it exits the laser source and the direction of the same beam as it enters the camera after it is deflected by the work piece, along with knowledge about the relative position between the camera and the laser source, allows to measure the distance to the work piece with high accuracy.

Another advantage of arranging the camera at an angle with respect to the laser source, is that this allows the direct detection of rat holes, drain holes, ends of profiles, etc. so that the welding plan can account for such ‘abnormalities’ directly, also when the profile includes a horizontal portion at the top thereof.

Accordingly, the time it takes to complete the scanning process may be reduced by as much as 50%, or even more, compared to prior methods. Of course, the majority of the time is still spent by actually welding the profiles to the base plate and/or each other, a part of the process that is hardly or not sped up with the present method compared to previous welding processes planned with the use of the applicant's proprietary RinasWeld program.

Further advantageously, it is no longer needed to have any 2D or 3D computer drawing of the work piece, while it can still be welded automatically. Neither required is a database containing all different profiles. The absence of these requirements makes automatic welding available to many more workshops around the world compared to previous automatic welding methods which did require such databases or computer design drawings.

Also, it is now possible to automatically detect and plan for unique profiles and unique abnormalities.

Yet another advantage of the present method, as confirmed by tests, is that the setup as described herein, compared to a method using a LIDAR technique, is much better able to cope with reflective surfaces, e.g. polished surfaces, of the work piece, in that the data set obtained for such surfaces much more accurately reflects the real world situation.

A further advantage of the present method is that information regarding weld lines can be obtained during the first scan, already and irrespective of the used profile, as the angular orientation of the camera with respect to the laser beam emitted by the laser source allows the sensor to e.g. “look under” T-profiles and other profiles with a top portion. Also this is not necessarily possible when a LIDAR technique is used.

According to the present invention, a weld plan for a work piece may be generated automatically. The word automatically does not per se imply that no human actions are required at all. For example, human actions may still be required to provisionally set up the work piece, e.g. by provisionally mounting the profiles on the base plate with spot welds. Also, it may be required in certain embodiments that a human operator verifies certain conditions/assumptions while the process is carried out, and/or that a human operator provides some input values before the method can be carried out successfully.

As explained in the above, the present method is mainly aimed at unique or semi-unique work pieces, e.g. work pieces having relatively high margins of uncertainty in the positioning and dimensioning of the components thereof. When serial production is desired, it will likely be more efficient to pre-program welding actions of a welding robot without deriving a weld plan for each work piece.

The work piece subjected to the method typically comprises a base plate and one or more profiles that protrude upwardly from the base plate. For example, these profiles may be provisionally attached to the base plate by spot welding. When carrying out the method, weld seams will be defined at the contact lines between the profiles and the base plate. In embodiments, the profiles may also contact each other. In such embodiments, weld seams may further be defined at the contact lines of two respective profiles.

In accordance with the present invention, the sensor comprises a camera and a laser which are arranged in a fixed position with respect to each other. Additionally, the sensor itself may be arranged at an angle compared to a line normal to the workpiece, so that the laser source projects the laser line onto the work piece at a first angle, and the camera looks at the laser light at a second angle that is larger than the first angle. Fixing the relative orientation of the sensor with respect to the laser source, has the advantage that the trigonometric calculation to calculate the height of the laser line, as projected on the work piece, with respect to either the camera or the laser source is always the same, and no uncertainties slip into the calculation as a result of a possible measurement error in the orientation of the one versus the other. Preferably, some sort of calibration is performed between the laser source and the camera before carrying out the first movement step of the above-defined method.

In accordance with the present invention, in principle any laser source that can generate a laser beam may be used. It may however be advantageous when a laser beam of a certain width can be generated, e.g. with an arcuate shape spanning e.g. 20-180 degrees.

In accordance with the present invention, in principle any camera that can record, with the help of processors, the distance to the laser line projected by the laser source may be used.

In a first prototype of the applicant a Wenglor MLWL275 sensor was used for this purpose. However, other sensors are most likely able to generate satisfactory results too.

In accordance with the present invention, the sensor is arranged above the work piece and faces towards the work piece. In a practical embodiment, the sensor may be arranged on a gantry beam while the work piece rests on the floor or a supportive structure. However, other options besides a gantry beam may be used as well.

In accordance with the present invention, the laser source and the sensor

In accordance with the present invention, in a first method step the sensor is moved across the work piece. Importantly, at this point in principle no prior knowledge about the work piece is required to carry out the method as described herein. In a practical embodiment this may be achieved by maintaining the work piece at a stationary location and moving the sensor. However, it is not excluded that the sensor remains stationary while the work piece is moved with respect to these components. The movement is preferably carried out until the entire surface of the work piece is inspected with the laser source and the camera. For example, an operator may manually indicate the dimensions of the work piece, or processing software may be able to determine an edge of the work piece while the movement step is performed. In accordance with the invention, the camera may measure the angle with which the laser beam, reflected from the work piece, is received. From the constant value of the angle between the laser source and the camera, this can be transformed into a distance between the camera and the object. From the constant value of the height between the substructure and the camera, this distance can be transformed into a local height of the work piece/height of the laser line.

In accordance with the invention, the local heights of the work piece may be gathered in a point cloud, e.g. having a resolution depending on the movement speed of the sensor with respect to the work piece and/or the processing power of the hardware components. Using dedicated software tools or programs these data points, e.g. the point cloud, may be merged to a 3D representation of the work piece, e.g. in a format often used in computer aided design programs and useable by other (computer) programs.

In accordance with the present invention, once the 3D representation of the work piece is generated, in a subsequent step contact lines between the profiles and the base plate may be obtained. At these contact lines, weld seams are defined for welding the profiles on the base plate and obtaining the work piece. Detecting contact lines may e.g. be carried out with the Rinas Weld program offered by the applicant but other software could be used as well.

Accordingly, in the final step a weld plan is generated for carrying out the welding. Preferably computer software tools are used to perform this step in an automated manner.

Preferably this step is followed by a step of automatically welding the profiles to the base plate according to the weld plan, e.g. with a robotic welding torch arranged above the work piece.

Generally speaking, the movement direction of the sensor with respect to the work piece does not significantly impact the results obtained-as long as the entire surface of the work piece is scanned.

In a practical embodiment of the invention, the movement of the sensor may be in the longitudinal direction of the work piece. Possibly, the movement is a continuous, rectilinear movement. Alternatively, e.g. depending on the processing power of the software, the movement may be an intermittent movement wherein the laser source and sensor intermittently move both backwards and forwards with respect to the work piece so that certain parts of the work piece can be scanned twice and a higher resolution, in the sense that there are more data points, may be obtained. In particular positions where a profile starts, ends, or meets another profile may require a double (triple, etc.) scanning to obtain a better data set and higher precision.

In an embodiment of the invention, the movement of the sensor is in the transverse direction of the work piece. Also in this direction, the movement may be continuous or intermittent, similar to what is described in the above. This movement may be combined with a longitudinal movement, so that the entire work piece is scanned twice, in two directions, for a better resolution. However scanning only in the longitudinal direction or only in the transverse direction may in embodiments also result in a satisfactory resolution, so that a movement in the other direction may be omitted.

In an embodiment of the invention, the laser beam as emitted from the laser source has an arcuate shape, e.g. with a width of in between 20° and 180°. Preferably, when moving the laser source along the work piece, at a particular cross-sectional area the entire work piece is radiated with laser light. Depending on the exact height between the work piece and the laser source, the beam emitted from the laser light must be larger or smaller to accomplish this.

In an embodiment of the invention, the colour of the laser light emitted by the laser source is blue, e.g. having a wavelength of 450-500 nm. Without wishing to be bound to a particular theory, it is surprisingly found by the applicant that scanning results obtained with blue laser light are more accurate and contain less noise than scanning results obtained with a red laser light.

In an embodiment of the invention, the local heights of the laser line are obtained in the form of a point cloud

In such an embodiment, to convert the local height data obtained as a point cloud to a 3D representation of the work piece, planes may be fitted on the point cloud. This has the advantage that even when in real life the profiles are imperfect, e.g. because they are bent to a higher or lower degree, the weld plan can be generated at a much faster rate. It is found in practice that a 3D representation based on plane fitting does not adversely affect the welding results obtained, as in cases where the 3D representation is available from the start (and the scanning method as described herein may not be used) this 3D representation likewise assumes that the profiles are straight while this may not be the case in practice. In practice, a welding robot may self-correct for such imperfections. Another advantage is that conversion of a point cloud to a 3D representation using plane fitting significantly increases the speed with which data/files are exported/exchanged as the 3D representation can then be generated with a smaller data set.

In an embodiment of the invention, the step of generating the 3D representation of the work piece includes a step of filtering any irrelevant objects, i.e. objects other than profiles, off of the base plate and/or filtering out any reflections and/or noise from the data obtained with the sensor. This may e.g. be achieved with dedicated pre-or postprocessing software and has the advantage that no welds are planned at positions where none are needed.

In an embodiment of the invention, the profiles arranged on the base plate further include an I profile, and/or a bar profile, the profile(s) possibly including a rathole, a tapered edge, and/or a cut-off, near or in the contact line. Advantageously all these shapes and abnormalities can be recognized by the method as described herein.

In an embodiment of the invention weld seams are further defined at the contact lines of two respective profiles. Besides welding profiles to the base plate it may be desired to weld two profiles together, e.g. along a vertical line defined by the contact line between the two profiles. The method advantageously allows to detect such contact lines as well.

A second aspect of the present invention relates to a method for automatically welding a work piece, the method comprising:
the steps as defined in the above, and
welding, with a welding torch, the profiles to the base plate according to the weld plan, to obtain the work piece.

Advantages obtained with the method according to the first aspect are likewise obtained with the method according to the second aspect. Embodiments described in relation to the first aspect in the above are likewise conceivable in a method according to the second aspect.

In particular, in an embodiment of the present invention a detailed measurement may be carried out in between the step of generating a weld plan and the step of welding, to determine the exact starting and/or end point of a weld seam, e.g. with a distance sensor integrated with the welding torch and/or with a contact sensor integrated with the welding torch.

Alternatively and/or additionally, a detailed measurement may be carried out while the step of welding is carried out, e.g. to determine a desired end point of the weld seam with greater precision. Such a measurement may likewise be carried out with a distance sensor integrated with a welding gun and/or with a contact sensor integrated with the welding torch.

It is noted that instead of performing a detailed measurement along the entire length of all profiles, only the start and/or end point of all or a subset of the profiles may be inspected more carefully. This will apply in particular at those positions where a resolution/precision of +/−1 mm is not achieved previously.

A third aspect of the present invention relates to a system for automatically generating a weld plan for a work piece comprising a base plate and one or more profiles that protrude upwardly from the base plate, in particular a (semi-)unique work piece the system comprising:
a laser source configured for generating a laser beam;
a camera configured for recording the laser beam, the camera arranged at a fixed position with respect to the laser source, at an angle of between 10° and 60° with respect to the centre line of the laser beam emitted by the laser source,
the laser source and the camera forming a sensor that is configured to be arranged above the work piece, and to be moveable with respect to the work piece, and
   a processor configured for:
      calculating laser line height data representative of a local height of the laser line as projected on the work piece based on recordings provided by the camera;
      generating a 3D representation of the work piece, based on the local height data;
      defining weld seams at contact lines between the profiles and the base plate, based on the 3D representation of the work piece; and
      generating a weld plan based on the set of weld seams.

In other words the third aspect of the present invention relates to a system for carrying out the method according to the first aspect. Advantages obtained with the method according to the first aspect are likewise obtained with the system according to the third aspect. Embodiments described in relation to third first aspect in the above are likewise conceivable in a system according to the second aspect.

These and other details of the present invention will be elucidated further in the below, with reference to the attached figures. In these figures, like or same elements will be indicated with the same reference number.

### BRIEF DESCRIPTION OF THE FIGURES

FIG. 1 schematically shows one example of many different possible examples of a work piece for which a weld plan may need to be generated;

FIGS. 2A-2C schematically show some of many different details possible on the profiles of the work piece;

FIG. 3 schematically shows a possible embodiment of a sensor and laser source arranged above a work area;

FIG. 4 schematically shows a possible alternative embodiment of a sensor and laser source arranged above a work area;

FIGS. 5A and 5B schematically show the field of view of two different camera orientations;

FIG. 6A schematically shows a point cloud of the work piece of FIG. 1, obtained with the sensor and without prior knowledge about the work piece; and

FIG. 6B schematically shows the work piece of FIG. 6A after the point cloud is converted into a 3D representation.

### DETAILED DESCRIPTION OF THE FIGURES

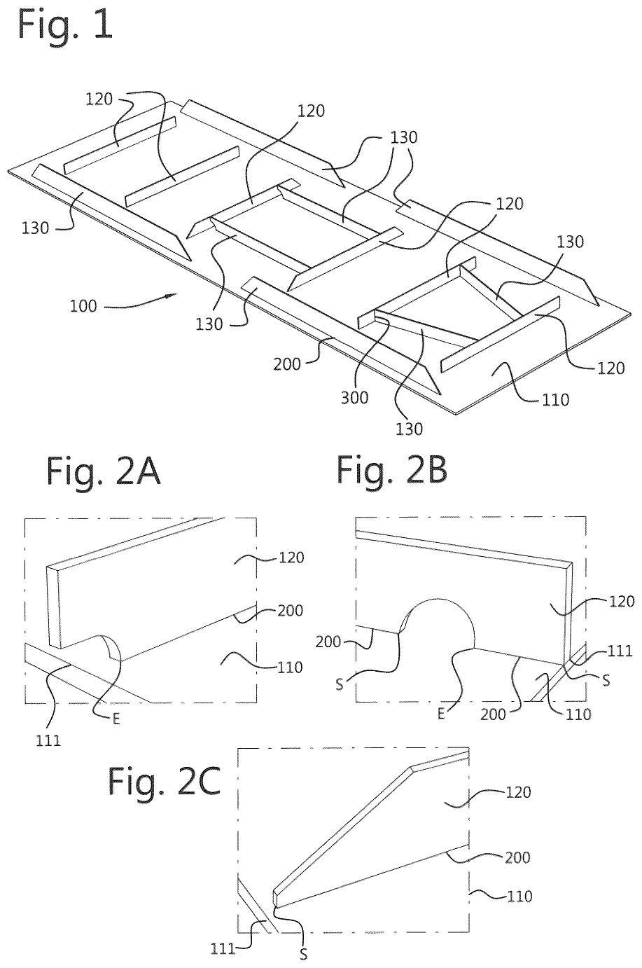

Starting with FIG. 1, schematically shown here is a work piece 100. The work piece 100 to which the method as herein described is typically applied is a unique or semi-unique work piece 100, e.g. a part of a large metal structure such as an offshore installation, a cruise boat, a naval vessel, or other similar structure. These structures are typically “one-offs”, designed to specification for the client. Sometimes a few identical structures may be made, but a series production is uncommon for these kinds of structures. Accordingly, a large number of work pieces 100 must be assembled so that from these work pieces 100 the structure can be created. The work piece 100 may e.g. have dimensions of several meters or several tens of meters in width and several meters or several tens of meters, up to one hundred meters or more in length. The work piece 100 comprises a base plate 110 and profiles 120, 130. As shown, the base plate 110 may comprise all sorts of cut-outs and the profiles 120, 130 may in principle be arranged anywhere on the base plate 110, in all directions. The profiles may e.g. have a height ranging between 5 cm and 50 cm and protrude upwardly from the base plate 110. The profiles 120, 130 are welded to the base plate 110 to form the work piece 100. Traditionally for unique structures this welding is performed by hand but robotic welding actions for such unique structures are desired to reduce the costs and/or to increase production capacity. The welding may be performed at the horizontal contact lines 200 between the profiles 120 and the base plate 110 and/or at the vertical contact lines 300 between two profiles 120, 130.

When a robotic welding action is desired to assemble the work piece 100, typically the profiles 120, 130 are first provisionally attached to the base plate 110, e.g. by hand, typically with spot or tack welds. It is to be understood that for these kinds of structures deviations in size and placement of the profiles 120, 130 can be relatively large, such that the weld plan can only be derived once the profiles 120, 130 are provisionally mounted to the base plate 110.

Shown in FIGS. 2A-2C are some non-limiting close up views of profiles 120 provisionally mounted to base plates 110. In FIG. 2A the contact line 200 between base plate 110 and profile 120 can be seen quite well, as well as the interrupted edge of the profile 120, the contact line 200 ending at point E. Accordingly, it is important that the weld plane to be generated ensures that the weld at contact line 200 stops at point E and does not continue all the way until the edge 111 of the base plate 110. In the embodiment shown in FIG. 2B a so-called rat hole is arranged in the profile 120. Also at such a rat hole the contact line 200 is interrupted and the weld seam cannot continue over the entire length of the profile 120. Here the start point S of the contact line 200 coincides with the edge 111 of the base plate 110, the contact line 200 ending at one side of the rat hole, at end point E. The contact line 200 then continues again at the opposite side of the rat hole, at the second point S. In the embodiment of FIG. 2C the profile 120 is tapered at the end, also referred to in the art as a ‘snipe’. Also for such profiles the start point S of the contact line 200 between profile 120 and base plate 110 is to be recognized clearly. It should be noted that all profiles shown in FIGS. 2A-2C are simple, straight, profiles 120, but instead of such straight profiles also other profiles shapes, including T-profiles, angled profiles, I profiles, bulb profiles, and/or bar profiles can be recognized with the method as disclosed herein-as will become more clear from the below.

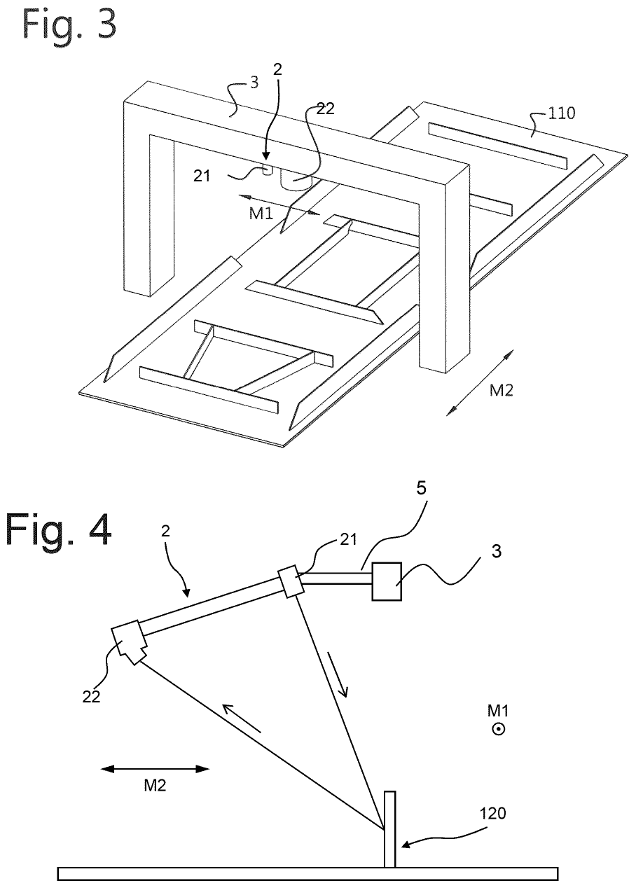

Turning now to FIGS. 3 and 4, an overhead gantry 3 is shown above a base plate 110. Referring to the embodiment shown in FIG. 3, below the gantry 3, above the base plate 110 and facing said base plate 110, are mounted a sensor 2 comprising a laser source 21 and a camera 22. The laser source 21 is configured for generating a laser beam as it moves across the work piece, the laser beam e.g. having a blue colour with a wavelength of between 450 and 500 nm. The camera 22 is configured for recording said laser beam as it moves across the work piece, e.g. to determine a distance (i.e. height) between the laser beam and the camera 22. In the embodiment of FIG. 3 a single camera 22 and a single laser source 21 are provided. For example, the laser beam emitted by the laser source 21 may have an arcuate shape having an emission angle of e.g. in between 20 and 180 degrees. If the emission angle is in the lower region of that range, say in between 20 degrees and 60 degrees, the camera 22 may be capable of viewing only a part of the base plate 110, when seen in the width dimension of the base plate 110. Hence, to allow the entire base plate to be inspected in such an embodiment, the sensor 2 may be able to move in movement direction M1, i.e. in the width or transverse direction of the base plate 110. For example, the sensor 2 may move along the length of the baseplate 110 once or as often as necessary, be shifted in the transverse direction of the baseplate 110, and be moved along the baseplate 110 again. As the sensor 2 can inspect only one cross-sectional area of the base plate 110 at the time, the sensor 2 can further be moved in the longitudinal direction M2 of the base plate 110. The movement along the base plate 110 can e.g. be a rectilinear and continuous movement. In other embodiments it may be advantageous when the sensor 2 moves back somewhat at certain points where more detail than average is needed to perform a second scan-possibly at a lower speed. Alternatively or additionally a second scan may be obtained by rotating the sensor 2 180 degrees about the axis normal to the work piece 100, and have the gantry return to its original position after the work piece 100 has been scanned for the first time. In the embodiment of FIG. 3 there is a single sensor 2, having a single laser source 21 and a single camera 22 that are arranged at fixed positions with respect to each other. As an alternative to FIG. 3, FIG. 4 shows in a cross-sectional view from the side how sensor 2, including laser source 21 and camera 22, is arranged in front of the gantry 3. In particular, the sensor 2 extends forwards with respect to gantry 3 due to extension element 5. As a result of the positioning in front of the gantry, the laser source 21 projects a laser line on the profiles 120 at an angle compared to a line normal to the base plate; said angle e.g. being in between 10 degrees and 25 degrees. As will be understood by one skilled in the art, the larger the angle between the orientation of the laser source 21 and the line normal to the base plate, the “deeper” the laser source can look under the upper bar of e.g. a T-profile. However, the larger the angle between the projection line of the laser source 21 and the line normal to the base plate, the longer extension element 5 must be and the more movement vibrations create a noise in the measurement results. It is found by the applicant that an angle of in between 10-25 degrees is optimal in that respect, accepting that the system is incompatible with some profiles 120 that have an exceptionally wide upper flange. Further shown is the camera 22, which is rigidly attached to the laser source 21 so that a distance between the camera 22 and the laser source 21 is fixed. The camera 22 is also arranged at an angle to the laser source 21, the camera 22 catching the light projected by the laser source 21 as shown. It will be understood that the exact angle between laser source 21 and camera 22 may depend on the height between gantry 3 and base plate 110. From this parameter and the fixed orientation of the camera 22 with respect to the laser source 21, the camera 22—especially when it is a “distance camera”, can determine the distance towards a profile as it looks at it. As the sensor 2 is then moved along the base plate as described in the above, a mapping of the base plate may be generated.

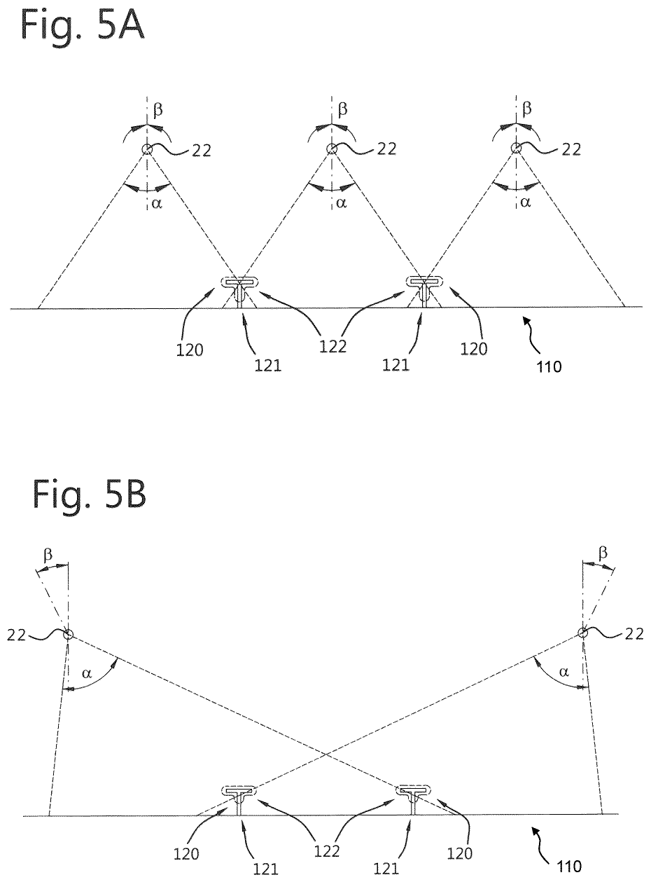

As is illustrated in FIG. 5A, when the camera 22 looks straight down, i.e. when the inclination angle β between the vertical and the centre line viewed by the camera 22 is 0 degree, only a very small lower portion 121 of profiles 120 can be seen by the camera 22 whereas a large upper portion 122 of the profiles cannot be seen by the camera 22. This lower portion is too small to reliably detect the contact line between the base plate 110 and the profile 120. In contrast, as shown in FIG. 5B, when the camera 22 is inclined such that the inclination angle β is e.g. between 10 and 60 degrees, the lower portion 121 of the profiles 120 that is visible becomes significantly larger. This larger portion 121 does allow to accurately determine the position of the contact line, and thereby the weld seam. When the camera 22 is arranged at an angle to the laser beam emitted by the laser source 21, the distance between the camera 22 and the laser line may be obtained using a technique known as ‘triangulation’.

Turning back now to FIGS. 3 and 4, as the laser source 21 and camera 22 move along the work piece, the sensor 2 measures e.g. a distance between the camera and the laser line as projected on the work piece. From this distance, a height of the laser line may be obtained, said height corresponding to the height of the work piece at that position. For example, as a scan of the entire surface of the work piece is completed, the measurements may be stored as data points each identifying a position and a height.

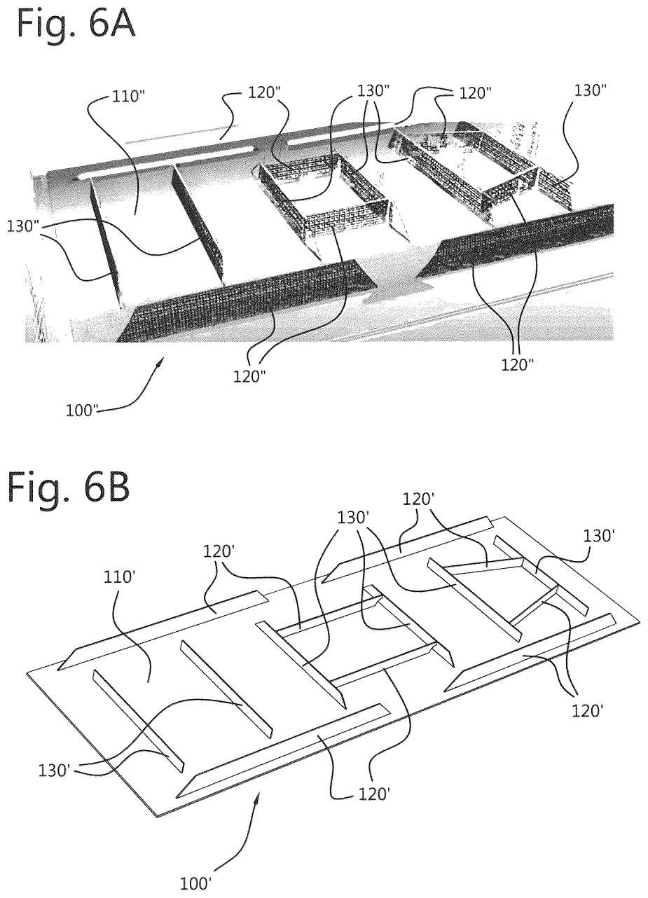

Using a software program all data points may subsequently be mapped in a point cloud. The result of such a mapping of the point cloud 100″ is shown in FIG. 6A. In the mapping the base plate 110″ as well as profiles 120″, 130″ are clearly recognizable. It should be pointed out explicitly that this image may be obtained without having any prior computer-rendered information about the work piece under view.

From this set of data points representing the local height of the profiles on the base plate, a 3D representation 100′ of the work piece can be generated. In a particularly advantageous embodiment this is achieved by fitting planes on the point cloud 100″, the set of planes together defining the 3D representation 100′. The 3D representation obtained from the point cloud 100″ shown in FIG. 6A with this method is shown in FIG. 6B. Advantageously, by fitting planes on the point cloud 100″, the precise location of any point for which information is lacking may be estimated based on the position of neighbouring points using the plane fitting method. Further advantageously, the individual planes can be described with relatively small data sets, so that the information about the work piece can be shared and exported at high speed while the work piece is being scanned. Again it is pointed out that the 3D representation 100′ is obtained without any prior computer-rendered information about it.

The step of generating the 3D representation 100′ of the work piece may include a step of filtering any irrelevant objects, i.e. objects other than profiles, off of the base plate. The step of generating the 3D representation 100′ of the work piece may additionally include filtering out any reflections and/or noise from the data obtained with the sensor 2. It should be noted that the filtering may be carried out exclusively for the purpose of generating a weld plan. When the movement path of the welding gun is planned, advantageously any objects that are irrelevant for welding purposes may become highly relevant, to avoid collision between the welding gun and such objects.

Once the 3D representation is generated, it is relatively easy to obtain the weld seams by identifying contact lines between the profiles and the base plate, and to derive a weld plan for welding the profiles to the base plate based on the identified set of weld seams. As such, a weld plan for a unique work piece may be generated automatically.

Of course, the above steps may be followed by a step of welding, with a welding torch, the profiles to the base plate, according to the weld plan, to obtain the work piece. Preferably this step is carried out by a robotic or automated welding torch.

Before initiating the welding it may be desirable to inspect certain areas of the work piece up close, e.g. to determine the exact starting point of a weld seam. For example this may be performed with a distance sensor integrated with the welding torch and/or with a touch sensor integrated with the welding torch.

Also during the welding process measurements may be carried out with a distance sensor integrated with the welding torch, e.g. to determine the end point of the welding seam with even more accuracy than based on the measurements performed with the sensor.

1. A method for automatically generating a weld plan for a work piece, in particular a (semi-)unique work piece,
the work piece comprising a base plate and one or more profiles that protrude upwardly from the base plate, the profiles including at least a T-shaped profile, an angled profile and/or a bulb profile, and/or a bulb profile, a top portion of the profiles being spaced apart from the base plate,
wherein use is made of a sensor comprising a laser source and a camera as well as a gantry,
the sensor extending forwards with respect to gantry due to an extension element, the laser source in use projecting a laser line on the profiles at an angle of in between 10° and 25° compared to a line normal to the base plate,
the camera arranged at a fixed position with respect to the laser source, at an angle of in between 10° and 60° with respect to the centre line of the laser beam emitted by the laser source,
wherein the laser source is configured for generating a laser beam and the camera is configured for recording said laser beam, the sensor being movable with respect to the work piece, wherein the method comprises the steps of:
a) moving the sensor across the work piece, while the laser source emits a laser beam that is projected on the work piece;
b) obtaining laser line height data, representative of a local height of the laser line as projected on the work piece, using the camera;
c) generating a 3D representation of the work piece, based on the local height data obtained with the sensor in step b);
d) based on the 3D representation of the work piece: defining weld seams at contact lines between the profiles and the base plate; and
e) generating a weld plan based on the set of weld seams.

2. The method according to claim 1, wherein, in step a), the movement of the sensor is in the longitudinal direction of the work piece.

3. The method according to claim 1, wherein, in step a), the movement of the sensor is in the transverse direction of the work piece.

4. The method according to claim 1, wherein in step a) the movement is an intermittent movement, the sensor configured to be moved both along and against the respective forward movement direction while the laser source projects a laser beam on the workpiece.

5. The method according to claim 1, wherein in step a) the movement is a continuous, rectilinear movement.

6. The method according to claim 1, wherein the laser beam as emitted from the laser source has an arcuate shape with a width of in between 20° and 180°.

7. The method according to claim 1, wherein the colour of the laser light emitted by the laser source is blue, e.g. having a wavelength of 450-500 nm.

8. The method according to claim 1, wherein in step b) the local heights of the laser line are obtained by the sensor as a point cloud, in particular while using a triangulation measurement.

9. The method according to claim 8, wherein in step c) the point cloud obtained in step b) is converted to a 3D representation of the work piece.

10. The method according to claim 9, wherein the 3D representation is obtained by fitting planes, preferably having straight edges, on the point cloud.

11. The method according to claim 1, wherein the step of generating the 3D representation of the work piece includes a step of filtering any irrelevant objects, i.e. objects other than profiles, off of the base plate and/or filtering out any reflections and/or noise from the data obtained with the sensor.

12. The method according to claim 1, wherein the profiles arranged on the base plate further include an I profile, and/or a bar profile, the profile(s) possibly including a rathole, a tapered edge, and/or a cut-off, near or in the contact line.

13. The method according to claim 1, wherein weld seams are further defined at the contact lines of two respective profiles.

14. A method for automatically welding a work piece, the method comprising:
the steps as defined in claim 1, and
welding, with a welding torch, the profiles to the base plate, according to the weld plan, to obtain the work piece.

15. The method according to claim 14, wherein in between the step of generating a weld plan and the step of welding a detailed measurement is carried out, to determine the exact starting point of a weld seam, e.g. with a distance sensor integrated with the welding torch.

16. The method according to claim 14, wherein during the step of welding a detailed measurement is carried out, to determine the exact end point of a weld seam, e.g. with a distance sensor integrated with the welding torch.

17. A system for automatically generating a weld plan for a work piece comprising a base plate and one or more profiles, including at least a T-shaped profile, an angled profile and/or a bulb profile that protrude upwardly from the base plate with a top portion of the profiles being spaced apart from the base plate, in particular a (semi-)unique work piece, the system comprising:
a gantry;
a laser source configured for generating a laser beam;
a camera configured for recording the laser beam, the camera arranged at a fixed position with respect to the laser source, at an angle of between 10° and 60° with respect to the centre line of the laser beam emitted by the laser source,
the laser source and the camera forming a sensor that is configured to be arranged above the work piece, the sensor extending forwards with respect to the gantry due to an extension element, so that the laser source in use projects a laser line on the profiles at an angle of in between 10° and 25° compared to a line normal to the base plate, and the sensor configured to be moveable with respect to the work piece, and
a processor configured for:
calculating laser line height data representative of a local height of the laser line as projected on the work piece based on recordings provided by the camera;
generating a 3D representation of the work piece, based on the local height data;
defining weld seams at contact lines between the profiles and the base plate, based on the 3D representation of the work piece; and
generating a weld plan based on the set of weld seams.
